(19) United States
(12) Patent Application Publication
(10) Pub. No.: US 2009/0061866 A1
(43) Pub. Date: Mar. 5, 2009

(54) Apparatus and method for power saving in a wireless communication system

(75) Inventor: Pil-Yong Hwang, Gimpo-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/229,978

(22) Filed: Aug. 28, 2008

(30) Foreign Application Priority Data
Aug. 28, 2007 (KR) 2007-0086710

(51) Int. Cl. H04Q 7/20

(52) U.S. Cl. 455/434

(57) ABSTRACT

An apparatus and method for power saving in a wireless communication system are provided. The method includes performing scheduling considering a channel state of at least one MS located in a service area during an ith scheduling interval, confirming if there is an MS not to be selected at an (i+1)^{th} scheduling interval according to the scheduling result of the ith scheduling interval, and if there is at least one MS not to be selected, controlling the MS not to estimate a channel for scheduling of the (i+1)^{th} scheduling interval.

### CROSS-REFERENCE TO RELATED APPLICATION(S) AND CLAIM OF PRIORITY

This application claims priority under 35 U.S.C. §119(a) to a Korean Patent Application filed in the Korean Intellectual Property Office on Aug. 28, 2007 and assigned Serial No. 2007-86710, the contents of which are herein incorporated by reference.

### TECHNICAL FIELD OF THE INVENTION

The present invention relates to an apparatus and method for scheduling in a wireless communication system and, in particular, to an apparatus and method for reducing a power consumption of a mobile station (MS) that feeds back channel information for scheduling in the wireless communication system.

### BACKGROUND OF THE INVENTION

A wireless communication system uses a limited radio resource and, thus, cannot provide a service to many mobile stations (MSs) during the same time resource. Thus, in the wireless communication system, a base station (BS) selects target MSs among MSs located in a service area through scheduling and provides a service to the selected target MSs. For example, the BS selects target MSs having good channel states through scheduling based on channel information of the MSs. Thus, the MSs estimate channels with the BS and transmit the estimation results to the BS so that the BS can perform scheduling taking into consideration channel information.

However, because the wireless communication system uses a limited radio resource, even the channel information sent by the MSs to the BS acts as an overhead.

Accordingly, the wireless communication system controls only MSs having channel states more than a reference value to transmit channel information to the BS, thus being capable of reducing an overhead caused by channel information transmission. That is, when the BS performs scheduling considering channel information, there is a lower probability that an MS having a bad channel state is selected through the scheduling by the BS. Thus, the MSs transmit channel information to the BS only when there is a higher probability that the MSs are selected through scheduling by the BS considering their own channel states.

However, there is a problem that, even when MSs having channel states less than a reference value do not transmit channel information in order to reduce a waste of radio resources, the MSs have to estimate channels with the BS, thus causing unnecessary power consumption.

### SUMMARY OF THE INVENTION

To address the above-discussed deficiencies of the prior art, it is a primary object of the present invention to substantially solve at least the above problems and/or disadvantages and to provide at least the advantages below. Accordingly, one aspect of the present invention is to provide an apparatus and method for reducing a power consumption of a mobile station (MS) that feeds back channel information in a wireless communication system.

Another aspect of the present invention is to provide an apparatus and method for controlling an MS having a lower probability of being selected through scheduling at a next scheduling interval not to estimate a channel in order to reduce a power consumption of the MS in a base station (BS) of a wireless communication system.

A further another aspect of the present invention is to provide an apparatus and method for selecting an MS having a lower probability of being selected through scheduling at a next scheduling interval using a balance factor in a BS of a wireless communication system, and controlling the selected MS not to estimate a channel.

The above aspects are achieved by providing an apparatus and method for power saving in a wireless communication system.

According to one aspect of the present invention, a method for reducing a power consumption of a mobile station (MS) in a base station (BS) of a wireless communication system is provided. The method includes performing scheduling considering a channel state of at least one MS located in a service area during an ith scheduling interval, confirming if there is an MS not to be selected at an (i+1)th scheduling interval according to the scheduling result of the ith scheduling interval, and if there is at least one MS not to be selected, controlling the MS not to estimate a channel for scheduling of the (i+1)th scheduling interval.

According to another aspect of the present invention, a method for reducing power consumption in a mobile station (MS) of a wireless communication system is provided. The method includes confirming scheduling information received from a serving base station (BS), and if a power saving mode is set to the scheduling information, operating in an idle mode without estimating a channel.

According to a further another aspect of the present invention, a base station (BS) apparatus of a wireless communication system is provided. The apparatus includes a scheduler, a controller, and a transmitter. The scheduler selects at least one target mobile station (MS) through scheduling considering a channel state of at least one MS located in a service area. The controller determines if there is an MS not to be selected at a next scheduling interval depending on the scheduling result. The transmitter transmits scheduling information that comprises information controlling the MS not to estimate a channel for scheduling of a next scheduling interval if there is the MS not to be selected at the next scheduling interval.

According to still another aspect of the present invention, a mobile station (MS) apparatus of a wireless communication system is provided. The apparatus includes a receiver and a controller. The receiver receives a signal from a serving base station (BS) The controller performs a control of operating in an idle mode without estimating a channel if a power saving mode is set to scheduling information among signals received from the serving BS.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a flow diagram illustrating a process of reducing a power consumption of a mobile station (MS) through scheduling in a base station (BS) of a wireless communication system according to an exemplary embodiment of the present invention;

FIG. 2 is a flow diagram illustrating a process of reducing power consumption in an MS of a wireless communication system according to an exemplary embodiment of the present invention;

FIG. 3 is a block diagram illustrating a construction of a BS for scheduling in a wireless communication system according to an exemplary embodiment of the present invention;

FIG. 4 is a block diagram illustrating a construction of an MS for reducing power consumption in a wireless communication system according to an exemplary embodiment of the present invention; and

FIGS. 5A, 5B, 5C, and 5D are diagrams illustrating power variables for selecting MSs for reducing power consumption in a BS of a wireless communication system according to an exemplary embodiment of the present invention.

### DETAILED DESCRIPTION OF THE INVENTION

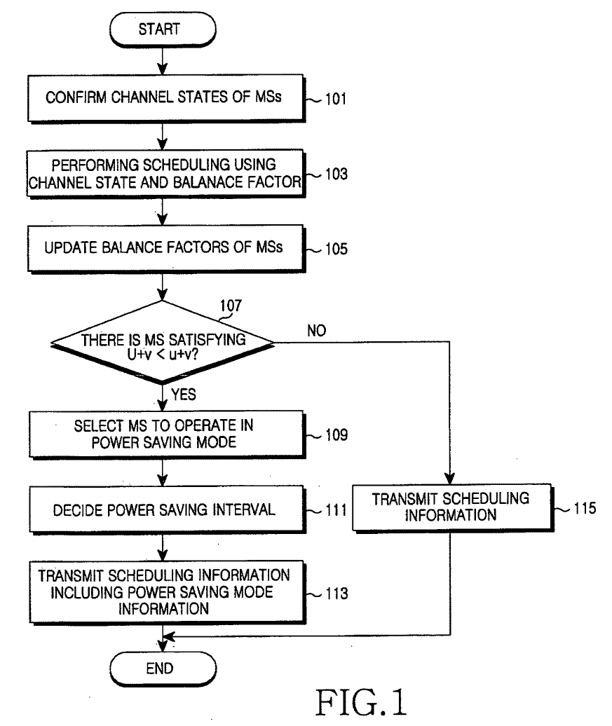

FIGS. 1 through 5D, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

A technology for reducing the power consumption of mobile stations (MSs) when performing scheduling considering channel states in a wireless communication system according to an exemplary embodiment of the present invention is described below. In other words, a technology for controlling MSs having a lower probability of being selected at a next scheduling interval not to estimate channels, thus reducing the power consumption of the MSs having the lower selection probability in the wireless communication system is described.

The following description is based on the assumption that a base station (BS) performs scheduling using channel states of MSs and balance factors. Because a radio channel greatly changes, It is difficult for the BS to predict channel states for MSs during a next scheduling interval. However, the BS can predict balance factors of MSs for a next scheduling interval depending on the scheduling result. Thus, in the following description, it is assumed that the BS selects an MS for reducing power consumption using a predictable balance factor. The balance factor represents a variable that is used for the BS to maintain a scheduling equity for MSs located in a service area. That is, when the BS performs scheduling considering channel states of MSs, MSs having bad channel states may not be continuously allocated resources. Thus, in order to maintain the equity of resource distribution through the scheduling, the BS performs scheduling considering both the balance factor and the channel state.

FIG. 1 is a flow diagram illustrating a process of reducing a power consumption of an MS through scheduling in a BS of a wireless communication system according to an exemplary embodiment of the present invention.

Referring to FIG. 1, in step 101, the BS confirms channel states of MSs located in a service area. For example, the BS confirms the channel states of the MSs in feedback signals received from the MSs.

After confirming the channel states of the MSs, in step 103, the BS selects a target MS through scheduling considering the channel states of the MSs and balance factors. For example, the BS compares sums of the channel states of the MSs and the balance factors with each other and selects a target MS starting from MSs having larger sums of channel states and balance factors. The BS selects target MSs for simultaneous service starting from the MSs having the larger sums of the channel states and balance factors.

After selecting the MSs through the scheduling, in step 105, the BS predicts balance factors for MSs located in a service area during a next scheduling interval. For example, the BS decreasingly changes balance factors of MSs selected through scheduling and increasingly changes balance factors of MSs not selected.

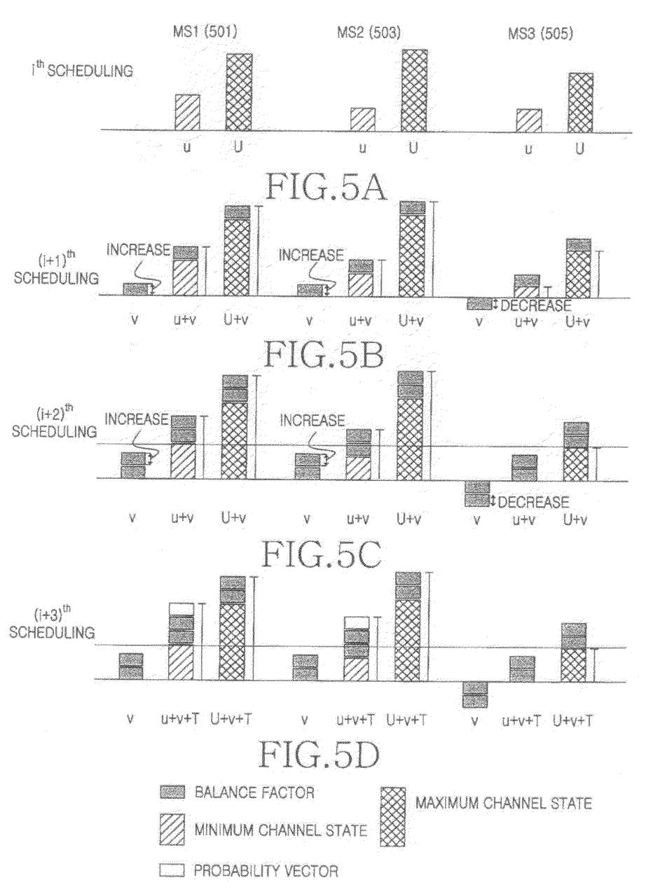

After predicting the balance factors of the MSs, in step 107, the BS determines if there is an MS to operate in a power saving mode during a next scheduling interval through a comparison between power variables of the MSs. The power variable includes a first power variable and a second power variable. The first power variable is a sum (U+v) of the maximum channel (U) available for MSs and a balance factor (v) updated in step 105. The second power variable is a sum (u+v) of the minimum channel (u) and the balance factor (v) updated in step 105. That is, the BS can calculate power variables using the channel states (U, u) of the MSs and the balance factors (v) as shown in FIG. 5 below.

FIGS. 5A, 5B, 5C, and 5D are diagrams illustrating power variables for selecting MSs for reducing power consumption in a BS of a wireless communication system according to an exemplary embodiment of the present invention.

In FIG. 5A, the BS confirms maximum channel state information (U) and minimum channel state information (u) available for MSs located in a service area during an ith scheduling interval.

In FIG. 5B, the BS can predict balance factors for the MSs of an (i+1)th scheduling interval using the scheduling information of the ith scheduling interval. For instance, when an MS3 505 is selected through scheduling at the ith scheduling interval, the BS can increase balance factors of an MS1 501 and an MS2 503 and decrease a balance factor of the MS3 505 and predict the balance factors for the MSs of the (i+1)th scheduling interval.

Thus, as shown in FIG. 5B, the BS can generate the first power variable and second power variable for the MSs of the (i+1)th scheduling interval using the channel state information (U, u) of the MSs and the predicted balance factors (v) of the MSs.

The BS recognizes an MS having a first power variable less than a second power variable of another MS among the MSs, as an MS to operate in a power saving mode. That is, when a first power variable of a specific MS is less than a second power variable of another MS, the BS recognizes the specific MS as an MS to operate in a power saving mode because the specific MS has a lower selection probability depending on a balance factor although having the maximum channel state during a next scheduling interval.

Thus, in step 107, as shown in FIG. 5, the BS confirms if there is an MS to operate in a power saving mode during a next scheduling interval through a comparison between the generated first power variables and second power variables of the MSs.

If there is not an MS to operate in a power saving mode in step 107, the BS transmits the scheduling information to the MSs in step 115. For example, in FIG. 5B, when power variables are generated for MSs during a next scheduling interval, there is not an MS having a first power variable less than a second power variable of another MS among the MSs. Thus, the BS determines that there is not an MS to operate in a power saving mode during a next scheduling interval.

If there is an MS to operate in a power saving mode in step 107, the BS confirms the MS to operate in the power saving mode during the next scheduling interval in step 109. For example, in FIG. 5, when the MS3 505 is selected through scheduling during the ith scheduling interval and (i+1)th scheduling interval, the BS can predict balance factors for the MS1 501, MS2 503, and MS3 505 of an (i+2)th scheduling interval during the (i+1)th scheduling interval and generate power variables as shown in FIG. 5C. Here, a first power variable of the MS3 505 is less than second power variables of the MS1 501 and MS2 503, and therefore, the BS selects the MS3 505 as an MS to operate in a power saving mode during the (i+2)th scheduling interval.

After confirming the MS to operate in the power saving mode, in step 111, the BS determines a power saving mode interval for the MS to operate in the power saving mode. For instance, when the MS3 505 is selected at the (i+1)th scheduling interval of FIG. 5B as an MS to operate in a power saving mode during the (i+2)th scheduling interval, the BS predicts a target MS to be selected at the (i+2)th scheduling interval using the power variables of the MS1 501 and MS2 503 of FIG. 5B. Alternatively, the BS can predict the target MS to be selected at the (i+2)th scheduling interval using power variables of the (i+2)th scheduling interval predicted as shown in FIG. 5C.

When selecting an MS2 503 having a lower second power variable of an (i+1)th scheduling interval as a target MS, the BS updates the balance factors of the MS1 501, MS2 503, and MS3 505 according to predicted scheduling information. Thereafter, the BS determines if the MS3 505 is to operate in a power saving mode even during an (i+3)th scheduling interval through a comparison between power variables of the MSs 501, 503, and 505 based on the updated balance factors. That is, if the predicted first power variable of the MS3 505 of the (i+3)th scheduling interval is more than second power variables of other MSs 501 and 503, the BS determines that the MS3 505 does not operate in a power saving mode during the (i+3)th scheduling interval.

If the predicted first power variable of the MS3 505 of the (i+3)th scheduling interval is less than the second power variable of the MS1 501 or MS2 503, the BS determines that the MS3 505 operates in a power saving mode even during the (i+3)th scheduling interval.

If the MS3 505 operates in the power saving mode even during the (i+3)th scheduling interval, the BS repeatedly performs the aforementioned operations, deciding a power saving mode interval of the MS3 505.

After deciding the power saving mode interval, in step 113, the BS transmits power saving mode information to the MS. Here, the BS transmits scheduling information including the power saving mode information to the MS.

Then, the BS terminates the process.

In the aforementioned exemplary embodiment of the present invention, the BS predicts an MS to be selected at a next scheduling interval and sets a power saving mode interval of the MS operating in a power saving mode. Alternatively, the BS may additionally select an MS having a first power variable less than a second power variable of another MS among MSs other than the MS having the power saving mode interval set, to operate the selected MS in a power saving mode.

In another exemplary embodiment of the present invention, the BS may not separately set a power saving mode interval of an MS operating in a power saving mode.

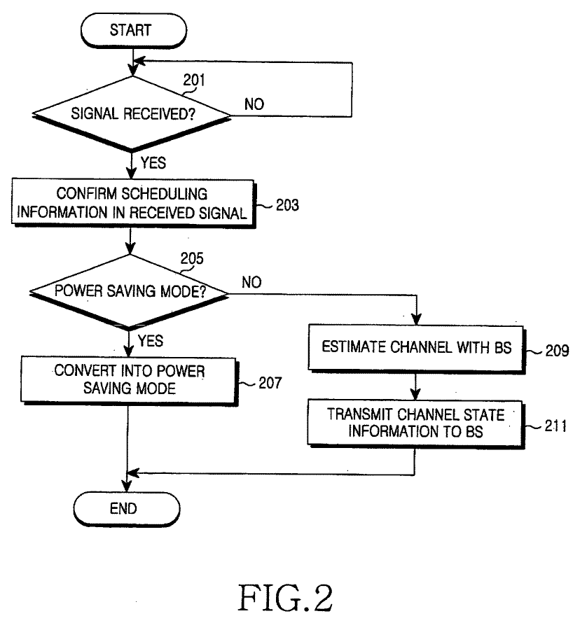

As described above, a BS predicts a balance factor for a next scheduling interval, thus selecting an MS to operate in a power saving mode. The MS operates as shown in FIG. 2 below.

FIG. 2 is a flow diagram illustrating a process of reducing power consumption in an MS of a wireless communication system according to an exemplary embodiment of the present invention.

Referring to FIG. 2, in step 201, the MS confirms if it receives a signal from a serving BS.

If the signal is received, in step 203, the MS confirms scheduling information in the received signal.

After confirming the scheduling information, in step 205, the MS determines if it is to operate in a power saving mode during a next scheduling interval.

If not operating in the power saving mode, in step 209, the MS estimates a channel with the serving BS.

After estimating the channel, in step 211, the MS transmits the channel state information to the serving BS. In order to reduce an overhead of a radio resource caused by channel state information transmission, the MS can transmit the channel state information to the serving BS only when the MS is in a good channel state. For example, when the estimated channel state is less than a reference value, the MS determines that the MS is in a bad channel state, thus not transmitting channel state information to the serving BS.

If operating in the power saving mode during a next scheduling interval in step 205, the MS converts into a power saving mode according to power saving mode information in step 207. Here, the MS does not perform a channel estimation operation for feeding back channel state information.

Then, the MS terminates the process.

A construction of a BS for selecting an MS to operate in a power saving mode during a next scheduling interval through scheduling is described below. The BS is assumed to use time division duplex (TDD) and orthogonal frequency division multiplexing access (OFDMA) schemes but may use other communication schemes.

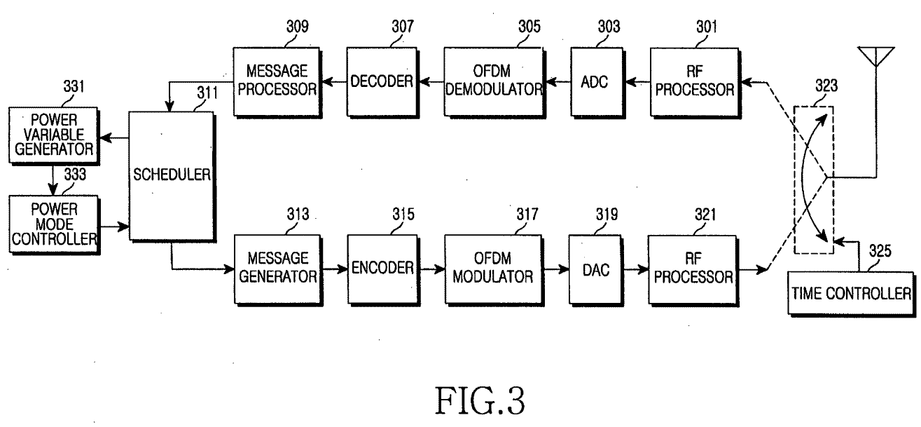

FIG. 3 is a block diagram illustrating a construction of a BS for scheduling in a wireless communication system according to an exemplary embodiment of the present invention.

Referring to FIG. 3, the BS includes radio frequency (RF) processors 301 and 321, an analog/digital converter (ADC) 303, an orthogonal frequency division multiplexing (OFDM) demodulator 305, a decoder 307, a message processor 309, a scheduler 311, a power variable generator 331, a power mode controller 333, a message generator 313, an encoder 315, an OFDM modulator 317, a digital/analog converter (DAC) 319, a switch 323, and a time controller 325.

The time controller 325 controls a switching operation of the switch 323 on the basis of frame synchronization. For example, in a signal reception mode, the time controller 325 controls the switch 323 to connect an antenna with the RF processor 301 of a receive end. In a signal transmission mode, the time controller 325 controls the switch 323 to connect the antenna with the RF processor 321 of a transmit end.

In the signal reception mode, the RF processor 301 converts an RF signal received from the antenna through the switch 323 into a baseband analog signal. The ADC 303 converts the analog signal received from the RF processor 301 into sample data. The OFDM demodulator 305 processes the sample data received from the ADC 303 by fast Fourier transform (FFT) and outputs frequency domain data.

The decoder 307 selects subcarrier data to be received from among the frequency domain data received from the OFDM demodulator 305. Then, the decoder 307 processes the selected data by demodulation and decoding according to a predefined modulation level. The modulation level includes a modulation and coding scheme (MCS) level.

The message processor 309 detects a control message received from the decoder 307 and provides the detected control message to the scheduler 311. For example, the message processor 309 detects channel state information of MSs located in a service area from feedback signals that are received from the MSs and provides the detected channel state information to the scheduler 311.

The scheduler 311 selects target MSs through scheduling using the channel state information of the MSs received from the message processor 309 and balance factors of the MSs.

The power variable generator 331 generates power variables of the MSs according to the scheduling information received from the scheduler 311. For example, the power variable generator 331 predicts balance factors of a next scheduling interval for the MSs according to the scheduling information and then, generates power variables of the MSs using the predicted balance factors as shown in FIG. 5B or 5C.

The power mode controller 333 selects an MS to operate in a power saving mode during a next scheduling interval through a comparison between the power variables of the MSs received from the power variable generator 331. The power mode controller 333 determines an MS having a first power variable less than a second power variable of another MS among the MSs, as an MS to operate in a power saving mode during a next scheduling interval. For example, as shown in FIG. 5C, the power variable generator 331 generates power variables of the MSs according to scheduling information of an (i+1)th scheduling interval of FIG. 5B. Here, a first power variable of the MS3 505 is less than the least second power variable of other MSs 501 and 502, and therefore, the power mode controller 333 selects the MS3 505 as an MS to operate in a power saving mode during a next scheduling interval.

If there is an MS to operate in a power saving mode, the power mode controller 333 determines a power saving mode interval of the MS to operate in the power saving mode. In detail, the power mode controller 333 predicts an MS to be selected at a next scheduling interval using generated power variables of MSs and determines a power saving mode interval of the MS to operate in the power saving mode. For example, when the MS3 505 is selected at the (i+1)th scheduling interval of FIG. 5B as an MS to operate in a power saving mode during an (i+2)th scheduling interval, the power mode controller 333 predicts a target MS to be selected at the (i+2)th scheduling interval considering the power variables of the MS1 501 and MS2 503 of FIG. 5B. If selecting an MS2 503 having a lower second power variable of an (i+1)th scheduling interval as a target MS, the power mode controller 333 updates the balance factors of the MS1 501, MS2 503, and MS3 505 according to predicted scheduling information. Then, the power mode controller 333 determines if the MS3 505 is to operate in a power saving mode even during an (i+3)th scheduling interval through a comparison between power variables of the MSs 501, 503, and 505 based on the updated balance factors. That is, when a first power variable of the MS3 505 is more than second power variables of the MS1 501 and MS2 503 at the predicted (i+3)th scheduling interval, the power mode controller 333 determines that the MS3 505 does not operate in a power saving mode during the (i+3)th scheduling interval.

When the first power variable of the MS3 505 of the predicted (i+3)th scheduling interval is less than the second power variable of the MS1 501 or MS2 503, the power mode controller 333 determines that the MS3 505 operates in a power saving mode even during the (i+3)th scheduling interval. When the MS3 505 operates in the power saving mode even during the (i+3)th scheduling interval, the power mode controller 333 repeatedly performs the above operation and determines a power saving mode interval of the MS3 505.

The power mode controller 333 can additionally select an MS having a first power variable less than a second power variable of another MS among MSs other than the MS that sets the power saving mode interval to operate the selected MS in a power saving mode.

After deciding the power saving mode interval, the power mode controller 333 transmits power saving mode information to the message generator 313 through the scheduler 311.

The message generator 313 generates a message including the scheduling information received from the scheduler 311. If there is an MS operating in a power saving mode during a next scheduling interval, the message generator 313 includes the power saving mode information in the message.

The encoder 315 processes the message received from the message generator 313 by coding and modulation according to a corresponding modulation level. The OFDM modulator 317 processes frequency domain data received from the encoder 315 by inverse fast Fourier transform (IFFT) and outputs sample data (that is, an OFDM symbol).

The DAC converter 319 converts the sample data received from the OFDM modulator 317 into an analog signal. The RF processor 321 converts the analog signal received from the DAC converter 319 into an RF signal and transmits the RF signal through the antenna.

In the above construction, the scheduler 311 controls the message processor 309, the power variable generator 331, the power mode controller 333, and the message generator 313. That is, the scheduler 311 can perform functions of the message processor 309, the power variable generator 331, the power mode controller 333, and the message generator 313. These are separately constructed and shown in order to distinguish and describe respective functions in the present invention. Thus, in actual realization, it can be constructed that the scheduler 311 can process all of the functions. Alternatively, it can be constructed that the scheduler 311 can process only part of them.

A construction of an MS for operating in a power saving mode during a next scheduling interval under the control of a BS is described below. The MS is assumed to use TDD and OFDMA scheme but may use other communication schemes.

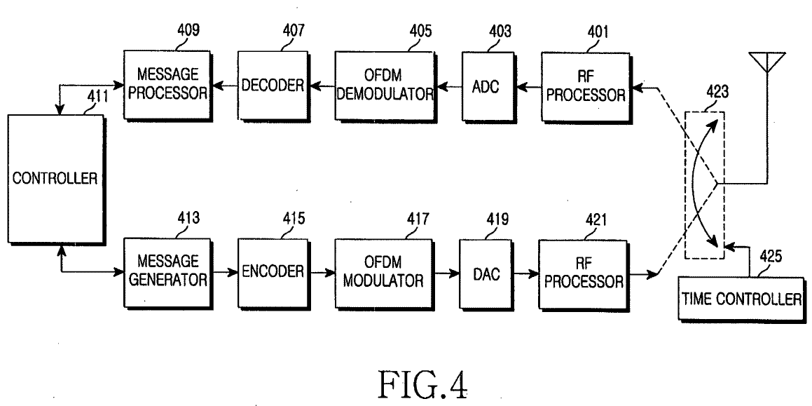

FIG. 4 is a block diagram illustrating a construction of an MS for reducing power consumption in a wireless communication system according to an exemplary embodiment of the present invention.

Referring to FIG. 4, the MS includes RF processors 401 and 421, an ADC 403, an OFDM demodulator 405, a decoder 407, a message processor 409, a controller 411, a message generator 413, an encoder 415, an OFDM modulator 417, a DAC 419, a switch 423, and a time controller 425.

The time controller 425 controls a switching operation of the switch 423 on the basis of frame synchronization. For example, in a signal reception mode, the time controller 425 controls the switch 423 to connect an antenna with the RF processor 401 of a receive end. In a signal transmission mode, the time controller 425 controls the switch 423 to connect the antenna with the RF processor 421 of a transmit end.

In the signal reception mode, the RF processor 401 converts an RF signal received through the antenna into a baseband analog signal. The ADC 403 converts the analog signal received from the RF processor 401 into sample data. The OFDM demodulator 405 processes the sample data received from the ADC 403 by FFT and outputs frequency domain data.

The decoder 407 selects subcarrier data to be received from among the frequency domain data received from the OFDM demodulator 405, and processes the selected data by demodulation and decoding according to a predefined modulation level. The modulation level includes an MCS level.

The message processor 409 detects a control message received from the decoder 407 and provides the detected control message to the controller 411. For example, the message processor 409 provides scheduling information received from a serving BS to the controller 411.

The controller 411 confirms if it operates in a power saving mode in the scheduling information received from the message processor 409. If not operating in the power saving mode, the controller 411 estimates a channel with the serving BS and provides the estimation result to the message generator 413. Here, the controller 411 decides if it feeds back channel state information depending on a channel state. For example, when the estimated channel state is good, the controller 411 provides the channel state information to the message generator 413. However, when the channel state is bad, the controller 411 does not provide the channel state information to the message generator 413.

If operating in the power saving mode, the controller 411 confirms a power saving mode interval. Then, the controller 411 performs a control of not estimating a channel by not transmitting channel state information to the serving BS during the power saving mode interval.

When receiving the channel state information from the controller 411, the message generator 413 generates a message including the channel state information.

The encoder 415 processes the message received from the message generator 413 by coding and modulation according to a corresponding modulation level. The OFDM modulator 417 processes frequency domain data received from the encoder 415 by IFFT and outputs sample data (that is, an OFDM symbol).

The DAC converter 419 converts the sample data received from the OFDM modulator 417 into an analog signal. The RF processor 421 converts the analog signal received from the DAC converter 419 into an RF signal and transmits the RF signal through the antenna.

In the aforementioned exemplary embodiment of the present invention, a BS selects an MS to operate in a power saving mode through a comparison between a first power variable comprised of maximum channels available for MSs and balance factors and a second power variable comprised of minimum channels available for the MSs and balance factors.

In another exemplary embodiment of the present invention, a BS may add a variable (hereinafter, referred to as “T”) based on a probability that the MS operating in the power saving mode uses the maximum channel and remaining MSs use the minimum channel to the second power variable, thus selecting an MS to operate in a power saving mode. That is, for the BS to compare the first power variable with the second power variable is to select an MS to operate in a power saving mode on the assumption that the MSs have the maximum channel and the minimum channel. However, there is a lower probability that an MS operating in a power saving mode among the MSs uses the maximum channel and remaining MSs use the minimum channel. Thus, the BS adds the ‘T’ to the second power variable, thus selecting the MS to operate in the power saving mode as shown in FIG. 5D. Here, as the ‘T’ increases, it can decrease a power consumption of an MS but has a negative influence on a scheduling policy.

Alternatively, the BS may compare only balance factors of the MSs with each other, thus selecting the MS to operate in the power saving mode.

As described above, there is an advantage that a BS of a wireless communication system can control an MS having a lower probability of being selected at a next scheduling interval not to estimate a channel, thus being capable of reducing a power consumption of the MS.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for reducing a power consumption of a mobile station (MS) in a base station (BS) of a wireless communication system, the method comprising:
performing a scheduling considering a channel state of at least one mobile station during an ith scheduling interval;
confirming if there is a mobile station not to be selected at an (i+1)th scheduling interval according to a scheduling result of the ith scheduling interval; and
if there is at least one mobile station not to be selected, controlling the mobile station not to be selected to refrain from estimating a channel for scheduling of an (i+1)th scheduling interval.

2. The method of claim 1, wherein the scheduling comprises:
confirming the channel states of the mobile stations and balance factors for scheduling equity; and
selecting at least one mobile station through scheduling considering the channel states of the mobile stations and the balance factors.

3. The method of claim 1, wherein confirming if there is a mobile station not to be selected at an (i+1)th scheduling interval comprises:
predicting one or more balance factors for a plurality of mobile stations of the (i+1)th scheduling interval according to the scheduling result; and
confirming if there is a mobile station from among the plurality of mobile stations not to be selected at the (i+1)th scheduling interval using the one or more predicted balance factors.

4. The method of claim 1, wherein confirming if there is a mobile station not to be selected at an (i+1)th scheduling interval comprises:
predicting one or more balance factors for a plurality of mobile stations of the (i+1)th scheduling interval depending on the scheduling result of the ith scheduling interval;
generating a first power variable and a second power variable for the respective mobile stations, the first power variable comprising a maximum channel for the respective mobile stations and a predicted balance factor, the second power variable comprising a minimum channel for the respective mobile stations and a balance factor; and
determining a mobile station having a first power variable less than the second power variables of the remaining mobile stations, as a mobile station not to be selected at the (i+1)th scheduling interval.

5. The method of claim 4, wherein predicting the one or more balance factors comprises:
decreasing the one or more balance factors for one or more target mobile stations that are selected through a scheduling; and
increasing the one or more balance factors for one or more mobile stations that are not selected through the scheduling.

6. The method of claim 1, wherein confirming if there is a mobile station not to be selected at an (i+1)th scheduling interval comprises:
predicting one or more balance factors for a plurality of mobile stations of the (i+1)th scheduling interval depending on the scheduling result of the ith scheduling interval;
generating one or more first power variables and one or more second power variables for the respective mobile stations, the one or more first power variables comprising a maximum channels for the respective mobile stations and one or more predicted balanced factors, the one or more second power variables comprising a minimum channels for the respective mobile stations, the one or more predicted balance factors, and a probability that a mobile station not to be selected at the (i+1)th scheduling interval among the plurality of mobile stations uses the minimum channel and the remaining mobile stations use the maximum channels; and
determining a mobile station having a first power variable less than second power variables of the remaining mobile stations, as a mobile station not to be selected at the (i+1)th scheduling interval.

7. The method of claim 1, further comprising: if there is a mobile station not to be selected,
deciding a size of an interval during which the mobile station refrains from estimating a channel; and
controlling the mobile station to refrain from estimating a channel during the decided interval.

8. The method of claim 7, wherein deciding the size of the interval comprises:
predicting the scheduling of the (i+1)th scheduling interval during the ith scheduling interval and predicting a target mobile station to be selected;
determining if the mobile station not to be selected at the (i+1)th scheduling interval also is not selected at an (i+2)th scheduling interval through the predicted scheduling result; and
if the mobile station is selected at the (i+2)th scheduling interval, deciding an interval for the mobile station to refrain from estimating a channel up to the (i+1)th scheduling interval.

9. The method of claim 8, wherein predicting a target mobile station to be selected comprises:
generating at least one power variable comprised of the minimum channel for the respective mobile stations and the balance factor, depending on the scheduling result of the ith scheduling interval; and
predicting a selection of at least one mobile station starting from a mobile station having a lowest of the power variables of respective mobile stations excluding the mobile station not to be selected at the (i+1)th scheduling interval.

10. The method of claim 1, wherein the controlling of the mobile station comprises:
generating a scheduling information that comprises a signal for controlling the mobile station to refrain from estimating the channel for the scheduling of the (i+1)th scheduling interval; and
transmitting the scheduling information to the mobile station.

11. A method for reducing power consumption in a mobile station (MS) of a wireless communication system, the method comprising:
confirming a scheduling information received from a serving base station (BS); and
if a power saving mode is indicated in the scheduling information, operating in an idle mode while refraining from estimating a channel.

12. The method of claim 11, further comprising: if the power saving mode is indicated in the scheduling information,
confirming a power saving mode interval information; and
operating in an idle mode during a power saving mode interval.

13. The method of claim 11, further comprising: if a power saving mode is not indicated in the scheduling information,
estimating a channel with the serving base station; and
transmitting an estimated channel state information to the serving base station.

14. A base station (BS) apparatus of a wireless communication system, comprising:
a scheduler for selecting at least one target mobile station (MS) through a scheduling considering a channel state of at least one mobile station located in a service area;
a controller for determining if there is a mobile station not to be selected at a next scheduling interval depending on the scheduling result; and
a transmitter for, if there is a mobile station not to be selected at the next scheduling interval, transmitting a scheduling information that comprises an information controlling the mobile station not to be selected to refrain from estimating a channel for a scheduling of a next scheduling interval.

15. The apparatus of claim 14, wherein the scheduler selects at least one target mobile station through the scheduling considering the channel states of a plurality of mobile stations and one or more balance factors for maintaining a scheduling equity.

16. The apparatus of claim 14, wherein the controller comprises:
a power variable generator for predicting the one or more balance vectors for the plurality of mobile stations of a next scheduling interval depending on the scheduling result; and
a power mode controller for confirming if there is a mobile station not to be selected at a next scheduling interval using the one or more predicted balance factors.

17. The apparatus of claim 16, wherein the power variable generator predicts the one or more balance factors for the plurality of mobile stations of a next scheduling interval depending on the scheduling result and generates at least one first power variable and at least one second power variable, the first power variable comprising a maximum channel of the respective mobile stations and a predicted balance factor, the second power variable comprising a minimum channel of the respective mobile stations and the one or more predicted balance factor.

18. The apparatus of claim 17, wherein the power mode controller determines a mobile station having a first power variable less than the second power variables of the remaining mobile stations, as a mobile station not to be selected at a next scheduling interval.

19. The apparatus of claim 14, wherein, if there is a mobile station not to be selected, the controller determines a size of an interval during which the mobile station refrains from estimating a channel.

20. A mobile station (MS) apparatus of a wireless communication system, comprising:
a receiver for receiving a signal from a serving base station (BS); and
a controller for, if a power saving mode is indicated in a scheduling information of the signal received from the serving base station, performing a control of operating in an idle mode while refraining from estimating a channel.

21. The apparatus of claim 20, wherein, if the power saving mode is set, the controller identifies a power saving mode interval information and controls to operate in an idle mode during a power saving mode interval.
